(19) United States
(12) Patent Application Publication
(10) Pub. No.: US 2006/0200691 A1
(43) Pub. Date: Sep. 7, 2006

(54) Cancellation of initiation of hibernation process

(76) Inventors: Takashi Yomo, Kanagawa-wan (JP); Yuka Matsuya, Kanagawa-wan (JP)

Correspondence Address: LAW OFFICES OF MICHAEL DRYJA, 704 228TH AVENUE NE, PMB 694, SAMMAMISH, WA, 98074, US

(21) Appl. No.: 11/073,215

(22) Filed: Mar. 5, 2005

(51) Int. Cl. G06F 1/26

(52) U.S. Cl. 713/323

(57) ABSTRACT

The hibernation of a computing device is initiated in response to user input. The operating system of the computing device initiates a termination process as part of hibernation. Prior to completion of the process, a particular driver detects user input to cancel hibernation. Before terminating, the operating system inquires to a number of drivers regarding whether hibernation should continue. The particular driver responds that hibernation should not continue, and the operating system thus cancels hibernation. In another embodiment, the user does not provide input to cancel hibernation until after the termination process has been completed. Upon completion of the process, the current state of the computing device is saved. Prior to completely saving the current state, firmware detects the user input to cancel hibernation. Once the current state has been completely saved, the firmware initiates a return-from-hibernation process by the operating system, without powering off the computing device.

### FIELD OF THE INVENTION

The present invention relates generally to the hibernation process in which a computing device can enter, and more particularly to canceling the hibernation process once it has been initiated.

### BACKGROUND OF THE INVENTION

Historically, a computing device, such as a desktop computer or a portable computer like a notebook or laptop computer, had two different power states: a power-on state, and a power-off state. In the power-on state, the computing device was utilizable by a user, and power was applied to all components of the computing device. In the power-off state, the computing device was not utilizable by a user, and power was removed from all or nearly all components of the computing device. For instance, in the case of a portable computer, power may only be provided to a battery recharging circuit in the power-off state.

More recently, computing devices have been able to enter additional power states, besides the power-on and power-off states. One power state is the sleep state. In the sleep state, power consumption by many components of a computing device is lowered or eliminated completely. For instance, the display screen of a computing device may be turned off, the hard drives may stop spinning their spindles, and the processor may operate in a reduced-power mode. The sleep state is especially useful where a user has his or her work interrupted periodically for short lengths of time, and therefore wants to be able to resume work on the computing device immediately when desired, but still desires to minimize power consumption. Typically, the pressing of a key on the keyboard, or the actuation of a pointing device, causes a computing device to exit the sleep state.

Another power state is the hibernation state. The hibernation state is similar to the power-off state, in that once a computing device has entered the hibernation state, power is removed from all or nearly all components of the computing device. However, in the power-off state, the operating system of the computing device is typically completely shut down before entering the power-off state. When the computing device is turned back on, it must completely reboot again, and enters the power-on state afresh. By comparison, in the hibernation state, before power is removed from all or nearly all components of the computing device, the current state of the operating system is saved to a non-volatile storage device, like a hard disk drive. When the computing device is turned back on, it reboots back into the previously saved state, so that the user is able to continue work from the point at which hibernation was entered.

With portable computers especially, the ability to enter the sleep or hibernation state quickly is desirable, so that the user can best manage power usage of the computer. To this end, many portable computers have special key sequences that when entered by the user causes a portable computer to enter the sleep or hibernation state. For example, many laptop and notebook computers allow entry into the hibernation state by pressing the Fn key and the F12 key. Entry into the hibernation state can take a few minutes after actuation of the key sequence in question, because saving the current state of the operating system to a non-volatile storage device takes time.

Laptop and notebook computers also typically have special key sequences for other operations. For example, many laptop and notebook computers allow an external VGA connector to become active in response to the entry of the Fn key and the F7 key. Thus, when a user is in a conference room; has connected his or her portable computer to a projector, and wishes to allow all the participants in the conference to view the contents of the display of the computer, he or she presses the Fn and F7 keys to activate the external VGA connector, so that the contents of the display of the computer are also sent to the projector.

However, often a user may press the wrong key sequence. For example, the user may press the Fn and F12 keys, instead of the Fn and F7 keys, when desiring to activate the external VGA connector. In response to actuation of the Fn and F12 keys, the computing device thus enters the hibernation state, in contradistinction to the user's intentions. The user therefore has to wait until the computing device has completely entered hibernation, turn the computer back on, and wait for the computing device to reboot back to the previously saved state. This process can take many minutes however, which can be inconvenient to the user.

For this and other reasons, therefore, there is a need for the present invention.

### SUMMARY OF THE INVENTION

The invention relates to the cancellation of the hibernation process once this process has been initiated. A method of the invention includes initiating the hibernation of a computing device in response to user input. The operating system of the computing device initiates a termination process as part of hibernation. Prior to completion of the termination process, a particular driver detects user input to cancel hibernation. Before completely terminating, the operating system inquires to a number of drivers, including the particular driver in question, as to whether hibernation should continue. The particular driver responds that hibernation should not continue, due to its detection of the user input to cancel hibernation. Therefore, the operating system cancels hibernation in response to the indication by the particular driver.

In another embodiment of the invention, the user may not provide user input to cancel hibernation until after the termination process by the operating system has been completed. In this embodiment, upon completion of the termination process, the current state of the computing device when hibernation was initiated is written to a storage device. Prior to completion of writing the current state to the storage device, firmware detects the user input to cancel hibernation, and sets a corresponding flag. Once the writing of the current state to the storage device has been completed, the firmware detects that the flag has been set. In response, the firmware initiates a return-from-hibernation process by the operating system, without powering off and on the computing device, and without performing a power-on self test (POST).

In another embodiment of the invention, in response to initiation of hibernation or power shutdown of the computing device by the user, a message is displayed instructing how the user is able to cancel the hibernation. In response to receiving user input to cancel the previously initiated process, prior to completion of hibernation or power shutdown, the previously initiated process is cancelled. Otherwise, the computing device shuts down or hibernates as appropriate.

A computing device of the invention includes a user input mechanism, a number of drivers, and an operating system. The user input mechanism is that by which a user is able to signal initiation and cancellation of hibernation of the computing device. The drivers include a particular driver to detect user input to cancel the hibernation. The operating system, prior to completing a termination process initiated as a result of user initiation of hibernation, inquires to the drivers as to whether hibernation should continue. The operating system cancels hibernation if any driver indicates that hibernation should be cancelled.

In another embodiment of the invention, the computing device also includes a non-volatile storage device, and a firmware, such as a basic input/output system (BIOS). The storage device is that to which the current state of the computing device is written upon completion of the termination process. The BIOS is to set a flag in response to detecting user input to cancel hibernation, and to initiate a return-from-hibernation process by the operating system without powering off and on the computing device and without performing a POST.

An article of manufacture of the invention includes a computer-readable medium, and means in the medium. The computer-readable medium may be a recordable data storage medium, a modulated carrier signal, or another type of computer-readable medium. The means may be part of an operating system of a computing device. The means inquires to a number of drivers as to whether hibernation of a computing device should continue, and cancels the hibernation of the computing device in response to receiving indication from any driver that hibernation should not continue. The drivers include a particular driver to detect user input corresponding to cancellation of hibernation after an operating system termination process has been initiated but before this process has been completed.

Embodiments of the invention provide for advantages over the prior art. Once the user has initiated hibernation of a computing device, he or she is able to cancel hibernation. Thus, if the user erroneously caused the computing device to begin hibernation, he or she does not have to wait for the computing device to completely enter the hibernation state, and then turn the computing device back on, which can take a long time. Rather, the user signals to the computing device that hibernation should be cancelled, and hibernation is cancelled generally more quickly than if the hibernation state were entered, and the user had to turn the computing device back on.

In one embodiment, the user signals cancellation of hibernation before the operating system has terminated. A driver detects the user's signaling. Before the operating system terminates completely, it inquires a number of drivers as to whether hibernation should be cancelled. The driver that detected the user's signaling indicates that hibernation should be cancelled. In this embodiment, then, hibernation is cancelled before the current state of the computing device has begun to be saved to a non-volatile storage device like a hard disk drive.

In another embodiment, the user signals cancellation of hibernation after the operating system has terminated, but before the current state of the computing device has been completely saved to a non-volatile storage device. Firmware, such as the BIOS of the computing device, detects the user's signaling. Once the current state of the computing device has been completely saved to the non-volatile storage device, the firmware immediately causes the computing device to restart. In this embodiment, hibernation is cancelled before the computing device has powered off, and as a result the POST of the computing device may not need to be performed.

Still other advantages, aspects, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram depicting how a driver, in response to user input, notifies the operating system that hibernation should be cancelled, prior to completion of a termination process by the operating system, according to an embodiment of the invention.

FIG. 2 is a flowchart of a method depicting how a driver, in response to user input, notifies the operating system that hibernation should be cancelled, prior to completion of a termination process by the operating system, according to an embodiment of the invention.

FIG. 3 is a diagram depicting how firmware, in response to user input, causes a computing device to not enter hibernation in response to a request from an operating system to do so, after completion of a termination process by the operating system, according to an embodiment of the invention.

FIG. 4 is a flowchart of a method depicting how firmware, in response to user input, causes a computing device to not enter hibernation in response to a request from an operating system to do so, after completion of a termination process by the operating system, according to an embodiment of the invention.

FIG. 5 is a diagram depicting how a user has to confirm entry of hibernation before the operating system is notified to begin entry of hibernation, according to an embodiment of the invention.

FIG. 6 is a flowchart of a method depicting how a user has to confirm entry of hibernation before the operating system is notified to begin entry of hibernation, according to an embodiment of the invention.

FIG. 7 is a rudimentary block diagram of a computing device, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

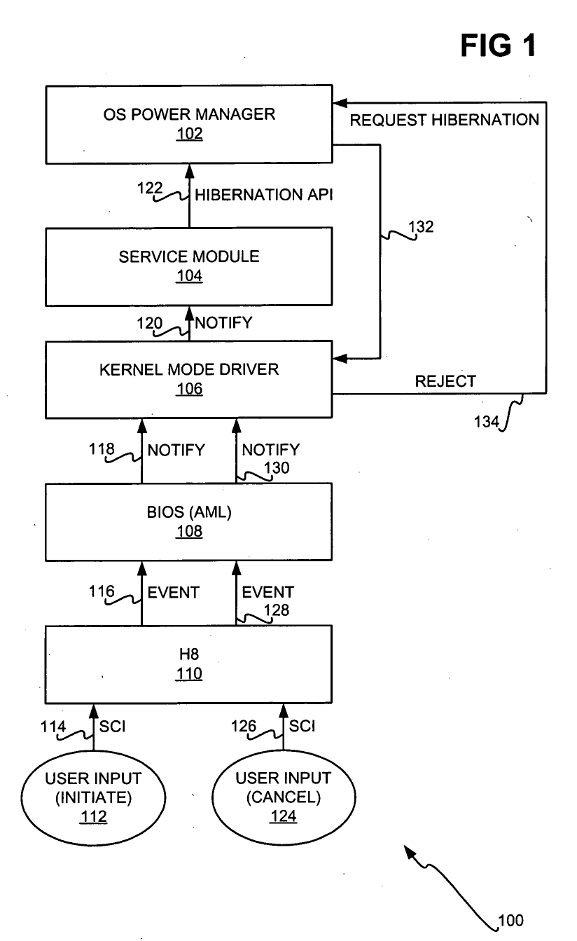

FIG. 1 shows a system 100, according to an embodiment of the invention. The system 100 includes an operating system power manager 102, which is a power management component of the operating system that handles power management activities for the operating system. For instance, the power manager 102 initiates a termination process by which the operating system, including all programs currently running on the operating system, is terminated. The power manager 102 thus initiates power shutdown, hibernation, sleep, and boot processes for the operating system.

The system 100 also includes a service module 104. The service module 104 is a component that interfaces with a hibernation application programming interface (API) of the operating system to instruct the power manager 102 to begin hibernation, such as to begin the termination process as an initial part of hibernation. The system 100 also includes a kernel mode driver 106. The kernel mode driver 106 is a driver that in the instance communicates information from a firmware, such as the basic input/output system (BIOS) 108, to the service module 104.

The system 100 also includes the BIOS 108. The BIOS 108 is a type of firmware, and in the context of embodiments of the invention, includes Advanced Configuration and Power Interface (ACPI) machine language (AML) to instruct the BIOS 108 to notify the kernel model driver 106 in response to receiving instructions that an ACPI power mode, such as hibernation, should be entered. The system 100 finally includes an H8 embedded keyboard controller (110), which is a controller that is capable of reporting certain keyboard events to the BIOS 108.

The system 100 operates as follows. First, user input 112 on the keyboard causes a system control input (SCI) to be asserted at the H8 controller 110, as indicated by the arrow 114. The user input 112 is to initiate entry into hibernation mode. In one embodiment, the user input 112 includes a particular key sequence, such as the Fn and F12 keys on the keyboard. In response, the H8 controller 110 sends an event to the BIOS 108, as indicated by the arrow 116. AML of the BIOS 108 then notifies the kernel mode driver 106, as indicated by the arrow 118. The kernel mode driver 106 notifies the service module 104, as indicated by the arrow 120. Therefore, the service module 104 calls the hibernation API of the power manager 102 to initiate hibernation, as indicated by the arrow 122.

In response to the call to initiate hibernation, the power manager 102 begins a termination process of the operating system. The termination process of the operating system shuts down all running processes on the operating system in an orderly fashion, in preparation for entry into hibernation. The termination process can take a few seconds to a few minutes, depending on the particular operating system and the number of processes currently running on the operating system.

Prior to completion of the termination process, additional user input 124 is asserted on the keyboard to cancel entry into hibernation mode, such as the pressing of the Fn and F12 keys. The user input 124 causes another SCI to be asserted at the H8 controller 110, as indicated by the arrow 126. The H8 controller 110 sends an event to the BIOS 108 in response, as indicated by the arrow 128. AML of the BIOS 108 then notifies the kernel mode driver 106, as indicated by the arrow 130. Thus, the kernel mode driver 106 is aware that the user wishes to cancel entry into hibernation mode.

Prior to completion of the termination process, as part of the termination process, the power manager 102 requests that all drivers, including the kernel mode driver 106 to enter hibernation, as indicated by the arrow 132. In response, however, the kernel mode driver 106 rejects instruction to enter hibernation, since the user has cancelled hibernation, as indicated by the arrow 134. Therefore, the request represented by the arrow 132 is effectively an inquiry by the operating system to the driver 106 as to whether hibernation should be cancelled, and the response represented by the arrow 134 is effectively a response by the driver 106 that hibernation should indeed be cancelled. In response to the rejection of the instruction by the driver 106, the operating system power manager 102 cancels entry into hibernation.

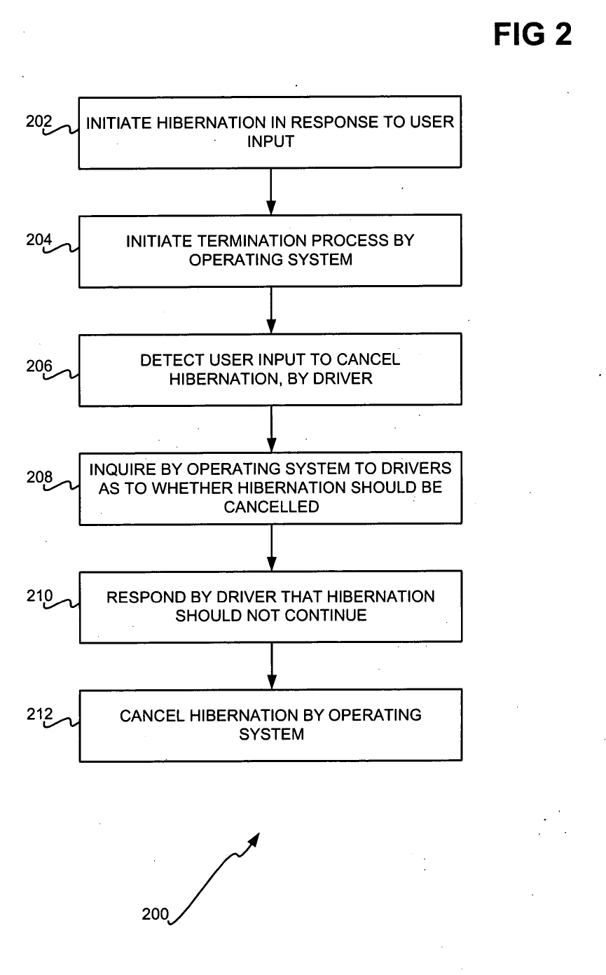

FIG. 2 shows a method 200 of the process described in relation to FIG. 1, according to an embodiment of the invention. Hibernation of a computing device, such as a desktop or portable computer, is initiated in response to user input (202). As part of hibernation, an operating system of the computing device initiates a termination process (204). A power manager component of the operating system may initiate this termination process. Prior to the completion of the termination process, user input by a particular driver, such as a kernel mode driver, is detected to cancel the hibernation (206).

The operating system, such as the power manager thereof, inquires to all the drivers as to whether hibernation should continue or be cancelled (208). In response, the particular driver that had detected user input to cancel the hibernation indicates that hibernation should be cancelled (210). Therefore, the operating system, such as the power manager thereof, cancels hibernation (212).

The cancellation of hibernation as has been described in relation to FIGS. 1 and 2 is useful where the user has provided user input to cancel hibernation before the operating system has completed the termination process. However, sometimes the user may not provide such user input to cancel hibernation until after the operating system has completed the termination process. At such time, the current state of the computing device may be in the process of being written to a non-volatile storage device, such as a hard disk drive. In another embodiment of the invention, cancellation of hibernation is accomplished in such situations as is now described.

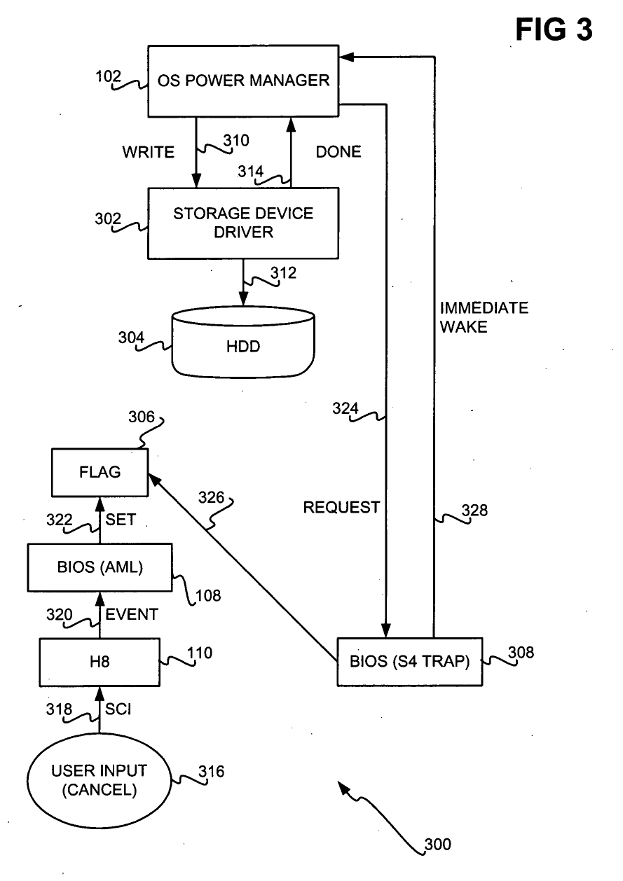

FIG. 3 shows a system 300, according to an embodiment of the invention. The system 300 again includes the operating system power manager 102, the BIOS 108, and the H8 controller 110. The system 300 also includes a storage device driver 302 and a hard disk drive 304. The storage device driver 302 is one type of input/output (I/O) management component for handling communications to storage devices, such as the hard disk drive 304, and other storage devices. In one embodiment, the storage device driver 302 may be an integrated drive electronics (IDE) bus manager.

The system 300 presumes that the power manager 102 has already finished the termination process in response to user input to enter hibernation, as has been described in relation to FIG. 1. The power manager 102 is now writing the current state of the computing device through the storage device driver 302, as indicated by the arrow 310, to the hard disk drive 304, as indicated by the arrow 312. Writing the current state of the computing device to non-volatile storage, such as the hard disk drive 304, is needed to enter hibernation so that when hibernation is exited, the computing device is capable of booting back to the point at which hibernation was initiated, as can be appreciated by those of ordinary skill within the art.

Prior to completion of writing the current state of the computing device to the hard disk drive 304, user input 316 is asserted on the keyboard to cancel entry into hibernation mode, such as pressing of the Fn and F12 keys. The user input 316 causes an SCI to be asserted at the H8 controller 110, as indicated by the arrow 318. The H8 controller sends an event to the BIOS 108 in response, as indicated by the arrow 320. AML of the BIOS 108 sets a flag 306 that can be part of the BIOS 108, as indicated by the arrow 322. The flag 306 being set thus is representative of the user's intention to cancel entry into hibernation.

Once the current state of the computing device has been completely written to the hard disk drive 304, as indicated by the arrow 314, the power manager 102 requests that the BIOS 108 enter S4 mode, as indicated by the arrow 324. S4 mode is a particular ACPI state synonymous with hibernation mode, in which the current state of the computing device is or has been suspended to a non-volatile storage. However, there is an S4 trap 308 that is part of the BIOS 108, which prevents the AML of the BIOS 108 from acting upon the S4 entry request indicated by the arrow 324.

The S4 trap 308 checks to see if the flag 306 has been previously set, as indicated by the arrow 326. If the flag 306 has not been set, then the S4 trap 308 passes the S4 entry request to the AML of the BIOS 108, so that hibernation may be entered. However, if the flag 306 has been set, then the S4 trap 308 of the BIOS 108 instructs the power manager 102 to immediately wake the operating system, such as by initiating a wake command, as indicated by the arrow 328. Such immediate waking means that the computing device is never powered down, and thus the computing device does not have to perform a power-on self test (POST), saving time in rebooting the operating system.

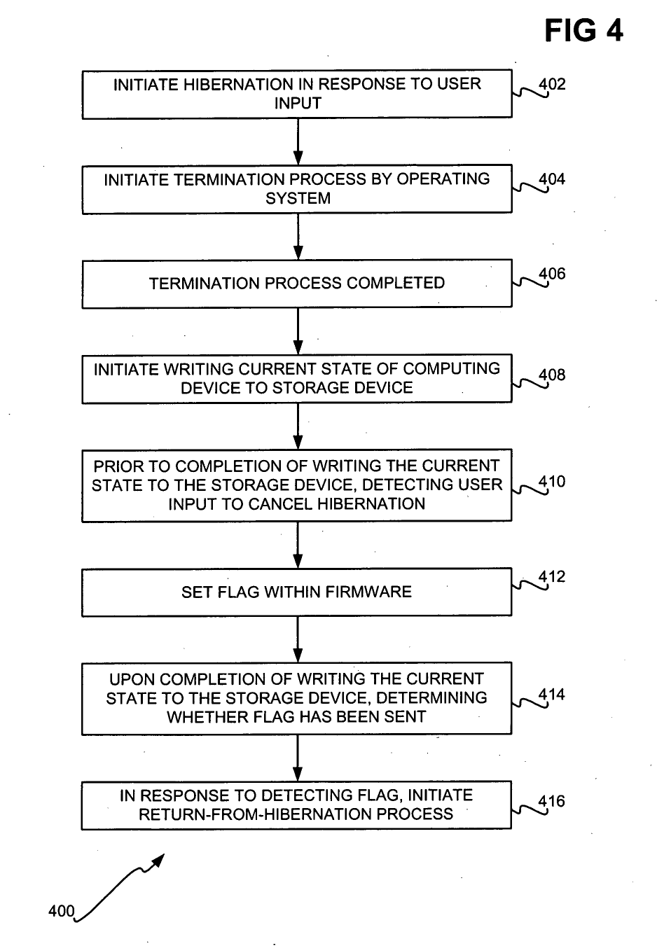

FIG. 4 shows a method 400 of the process described in relation to FIG. 3, according to an embodiment of the invention. Hibernation of a computing device, such as a desktop or portable computer, is initiated in response to user input (402). As part of hibernation, an operating system of the computing device initiates a termination process (404). This termination process is completed (406), and writing of the current state of the computing device to a storage device is initiated (408).

Prior to completion of writing the current state to the storage device, user input is detected to cancel hibernation (410). Such user input is detected by firmware, such as a BIOS. In response, the firmware sets a flag therewithin corresponding to the detection of the user input to cancel hibernation (412). Upon completion of writing the current state to the storage device, it is determined or detected whether the flag has been set (414). If it has, the operating system is caused to initiate a return-from-hibernation process (416), where the computing device is never powered off and a POST is not performed, such that the computing device never actually enters hibernation.

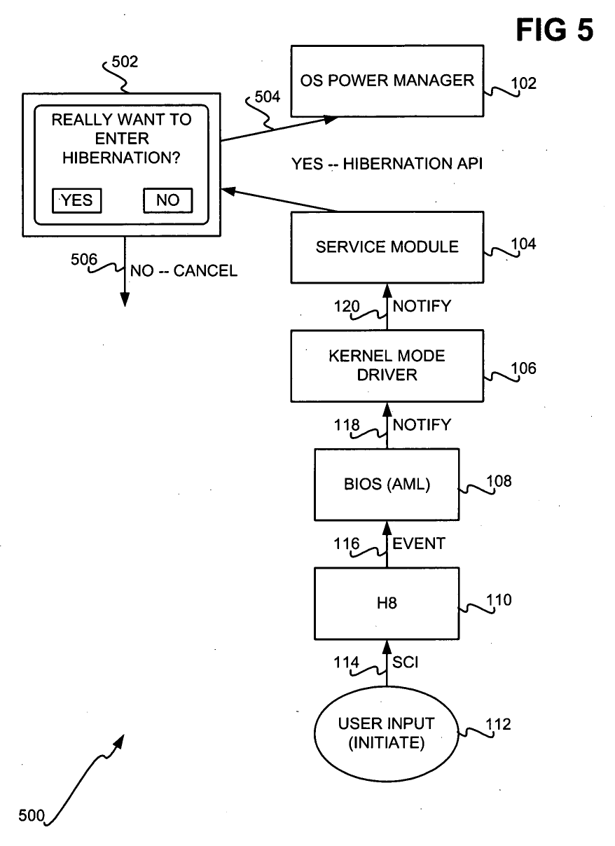

FIG. 5 shows a system 500, according to another embodiment of the invention. The system 500, like the system 100 of FIG. 1, includes the operating system power manager 102, the service module 104, the kernel mode driver 106, the BIOS 108, and the H8 controller 110. Each of these components operates in FIG. 5 at least substantially as has been described in FIG. 1.

The system 500 operates as follows. First, user input 112 on the keyboard causes a system control input (SCI) to be asserted at the H8 controller 110, as indicated by the arrow 114. The user input 112 is to initiate entry into hibernation mode. In one embodiment, the user input 112 includes a particular key sequence, such as the Fn and F12 keys on the keyboard. In response, the H8 controller 110 sends an event to the BIOS 108, as indicated by the arrow 116. AML of the BIOS 108 then notifies the kernel mode driver 106, as indicated by the arrow 118. The kernel mode driver 106 notifies the service module 104, as indicated by the arrow 120.

However, the service module 104 does not immediately call the hibernation API of the power manager 102 to initiate hibernation, as in FIG. 1. Rather, the service module 104 displays a window 502 to the user, asking for the user to confirm that hibernation should be initiated. If the user confirms that hibernation should be initiated, then the service module 104 calls the hibernation API of the power manager 102 to initiate hibernation, as indicated by the arrow 504, and the power manager 102 begins a termination process of the operating system, as has been described. If the user does not confirm that hibernation should be initiated, then hibernation is not entered, and thus is effectively cancelled, as indicated by the arrow 506.

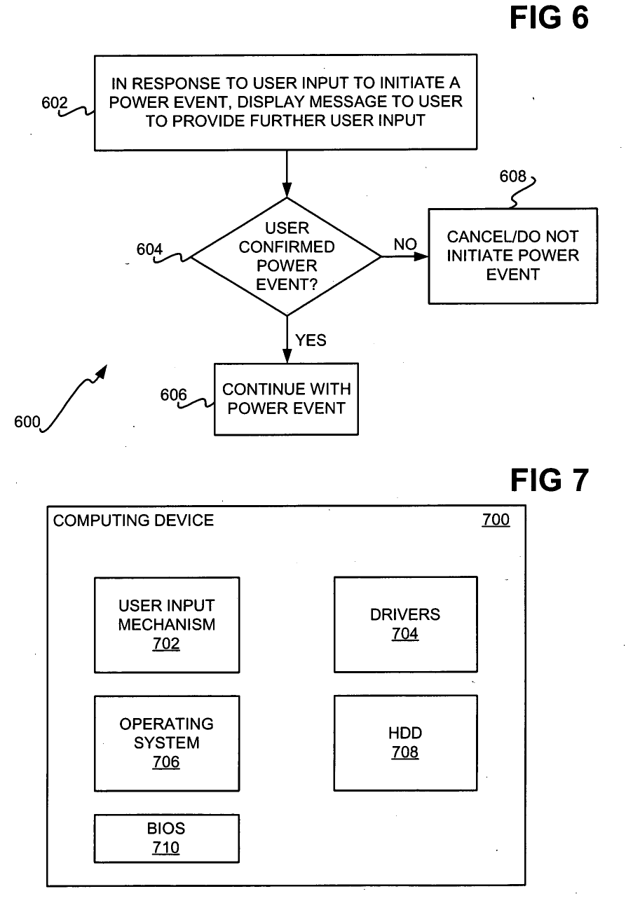

FIG. 6 shows a method 600 of the process described in relation to FIG. 5, according to an embodiment of the invention. However, the method 600 is more general than the process described in relation to FIG. 5, in that the method 600 is applicable to any type of power event. A power event may thus include hibernation, power shutdown of a computing device, and so on.

The method 600 presumes that a user has already provided user input to initiate a power event, such as hibernation or power shutdown. Thereafter, in response to such user input, a message is displayed to the user asking the user to provide further user input, to cancel or confirm the power event (602). If the user input received is a confirmation that the power event should indeed be initiated (604), then the method 600 continues with the power event (606), such as continuing or initiating hibernation or power shutdown. Otherwise, if the user input received is a cancellation that the power event should not be continued (604), then the method 600 cancels and otherwise does not initiate the power event in question (608).

FIG. 7 shows a rudimentary diagram of a computing device 700, according to an embodiment of the invention. The computing device 700 may be a desktop computer, a portable computer like a notebook or laptop computer, or another type of computing device. The computing device 700 is depicted in FIG. 7 as including a user input mechanism 702, drivers 704, an operating system 706, a hard disk drive 708, and a BIOS 710. The computing device 700 may further include other components, in addition to and/or in lieu of those depicted in FIG. 7, as can be appreciated by those of ordinary skill within the art. The computing device 700 particularly achieves cancellation of hibernation or another power event as has already been described in relation to FIGS. 1-6.

The user input mechanism 702 can be a keyboard or another type of user input mechanism. The mechanism 702 allows the user to signal initiation and cancellation of hibernation of the computing device 700. The drivers 704 of the computing device 700 includes at least one driver, such as a kernel mode driver, that is to detect user input at the user input mechanism 702 to cancel previous initiation of hibernation, as has been previously described in relation to FIGS. 1 and 2.

The operating system 706 initiates a termination process as a result of user initiation of hibernation. Furthermore, the operating system 706, prior to completion of the termination process, inquires the drivers as to whether hibernation should continue. If any of the drivers indicates that hibernation should be cancelled, then the operating system 706 cancels hibernation, and the computing device 700 does not enter hibernation. The operating system 706 may include a power management component to perform this functionality.

The BIOS 710, or other type of firmware, may receive an SCI from the user input mechanism 702, through an H8 or other type of controller, in response to the user signaling cancellation of hibernation, as has been described, where the BIOS 710 notifies one of the drivers 704, such as the kernel mode driver, thereafter. The hard disk drive 708, or other type of non-volatile storage, is that to which the operating system 706 is to write a current state of the computing device 700 upon completion of the termination process. In such an embodiment, the BIOS 710 is to set a flag in response to detecting user input to cancel hibernation, as has been previously described in relation to FIGS. 3 and 4.

Thus, the BIOS 710, such as a trap thereof, initiates a return-from-hibernation process by the operating system 706 immediately after receiving a request by the operating system 706 to cause the computing device 700 to enter hibernation through the BIOS 710. Therefore, the operating system 706 is woke without having the computing device 700 power off and on. Furthermore, the operating system 706 is woke without having a POST performed.

The user input mechanism 702 in this embodiment may provide an SCI through an H8 or other controller to the BIOS 710, and the BIOS 710 in response to the SCI sets the flag. The BIOS 710 initiates the return-from-hibernation process by the operating system 706 via a wake command, where the computing device 700 does not actually ever enter hibernation. Finally, the operating system 706 in one embodiment may display a message to the user after a power event such as hibernation has been initiated, such that the user is to provide further user input to cancel or confirm the power event. The operating system 706 does not commence with the power event, and cancels the power event, if the user indicates that the power event should not be continued.

It is noted that, although specific embodiments have been illustrated and described herein, it will be appreciated by those of ordinary skill in the art that any arrangement calculated to achieve the same purpose may be substituted for the specific embodiments shown. This application is intended to cover any adaptations or variations of embodiments of the present invention. Therefore, it is manifestly intended that this invention be limited only by the claims and equivalents thereof.

We claim:

1. A method comprising:
initiating hibernation of a computing device in response to user input;
initiating a termination process by an operating system of the computing device as part of the hibernation;
prior to completion of the termination process, detecting user input to cancel the hibernation by a particular driver;
inquiring by the operating system to a plurality of drivers including the particular driver as to whether the hibernation should continue;
responding by the particular driver to the operating system that the hibernation should not continue, due to detection of the user input to cancel the hibernation by the particular driver; and,
canceling the hibernation by the operating system in response to the particular driver indicating that the hibernation should not continue.

2. The method of claim 1, wherein a power manager component of the operating system inquires to the plurality of drivers as to whether the hibernation should continue.

3. The method of claim 1, wherein the particular driver is a kernel mode driver.

4. The method of claim 1, wherein the particular driver detects the user input to cancel the hibernation via a system control interrupt (SCI) corresponding to the user input being detected by firmware, the firmware notifying the kernel mode driver.

5. The method of claim 1, further comprising:
upon completion of the termination process,
initiating writing a current state of the computing device to a storage device;
prior to completion of writing the current state to the storage device, detecting user input to cancel the hibernation by firmware; and,
setting a flag within the firmware corresponding to detection of the user input to cancel the hibernation by the firmware.

6. The method of claim 5, further comprising:
upon completion of writing the current state to the storage device,
detecting whether the flag within the firmware has been set; and,
in response to detecting that the flag within the firmware has been set, initiating a return-from-hibernation process by the operating system, without powering off and on the computing device and without performing a power-on self-test (POST).

7. The method of claim 5, wherein the firmware detects the user input to cancel the hibernation via a system control interrupt (SCI) corresponding to the user input being detected by the firmware.

8. The method of claim 5, wherein the operating system initiates the return-from-hibernation process in response to the firmware initiating a wake command to the operating system without actually hibernating the computing device.

9. The method of claim 1, further comprising:
in response to initiation of the hibernation in response to the user input, displaying a message to a user to provide further user input to cancel the hibernation;
in response to receiving the further user input prior to completion of the hibernation, canceling the hibernation; and,
otherwise, hibernating the computing device.

10. The method of claim 1, further comprising:
in response to user input to initiate power shutdown, displaying a message to a user to provide further user input to cancel the power shutdown;
in response to receiving the further user input prior to completion of the power shutdown, canceling the power shutdown; and,
otherwise, shutting down the computing device.

11. A computing device comprising:
a user input mechanism by which a user is able to signal initiation and cancellation of hibernation of the computing device;
a plurality of drivers, including a particular driver to detect user input at the user input mechanism to cancel the hibernation; and,
an operating system to, prior to completion of a termination process initiated as a result of user initiation of the hibernation, inquire to the plurality of drivers, including the particular driver, as to whether the hibernation should continue, and to cancel the hibernation in response to indication by the particular driver that the hibernation should not continue.

12. The computing device of claim 11, wherein the operating system comprises a power management component to inquire to the plurality of drivers as to whether the hibernation should continue.

13. The computing device of claim 11, wherein the particular driver is a kernel mode driver.

14. The computing device of claim 11, further comprising a basic input/output system (BIOS), to which the user input mechanism provides a system control interrupt (SCI) in response to the user signaling cancellation of the hibernation of the computing device, the BIOS notifying the particular driver in response thereto.

15. The computing device of claim 11, further comprising:
a non-volatile storage device, to which a current state of the computing device is written upon completion of the termination process; and,
a basic input/output system (BIOS) to set a flag in response to detecting user input to cancel the hibernation, and to initiate a return-from-hibernation process by the operating system without powering off and on the computing device and without performing a power-on self-test (POST).

16. The computing device of claim 15, wherein the user input mechanism provides a system control interrupt (SCI) in response to the user signaling cancellation of the hibernation of the computing device, the BIOS setting the flag in response thereto.

17. The computing device of claim 15, wherein the BIOS initiates the return-from-hibernation process by the operating system by sending the operating system a wake command without actually hibernating the computing device.

18. The computing device of claim 11, wherein the operating system is to display a message to the user to provide further user input to cancel the hibernation once the hibernation has been initiated, and to cancel the hibernation in response to receiving the further user input.

19. An article of manufacture comprising:
a computer-readable medium; and,
means in the medium for inquiring to a plurality of drivers as to whether hibernation of a computing device should continue and to cancel the hibernation of the computing device in response to receiving indication from any of the drivers that hibernation should not continue,
wherein one of the plurality of drivers is to detect user input corresponding to cancellation of the hibernation after an operating system termination process has been initiated but before the operating system termination process has been completed.

20. The article of manufacture of claim 19, wherein the means in the medium is part of an operating system of the computing device, and the one of the plurality of drivers is a kernel mode driver of the operating system.
